(19) United States
(12) Patent Application Publication
(10) Pub. No.: US 2013/0048545 A1
(43) Pub. Date: Feb. 28, 2013

(54) Water Disinfection Using Deep Ultraviolet Light

(71) Applicants: Maxim S. Shatalov, Columbia, SC (US); Michael Shur, Latham, NY (US); Yuri Bilenko, Columbia, SC (US); Ignas Gaska, Columbia, SC (US); Alexander Dobrinsky, Providence, RI (US); Remigijus Gaska, Columbia, SC (US); Timothy James Bettles, Irmo, SC (US)

(72) Inventors: Maxim S. Shatalov, Columbia, SC (US); Michael Shur, Latham, NY (US); Yuri Bilenko, Columbia, SC (US); Ignas Gaska, Columbia, SC (US); Alexander Dobrinsky, Providence, RI (US); Remigijus Gaska, Columbia, SC (US); Timothy James Bettles, Irmo, SC (US)

(21) Appl. No.: 13/591,728

(22) Filed: Aug. 22, 2012

Related U.S. Application Data
(60) Provisional application No. 61/526,493, filed on Aug. 23, 2011.
(60) Provisional application No. 61/624,398, filed on Apr. 16, 2012.

(51) Int. Cl. B01D 29/00

(52) U.S. Cl. 210/96.1; 210/251

(57) ABSTRACT

A solution for treating a fluid, such as water, is provided. The solution first removes a set of target contaminants that may be present in the fluid using a filtering solution. The filtered fluid enters a disinfection chamber where it is irradiated by ultraviolet radiation to harm microorganisms that may be present in the fluid. An ultraviolet radiation source and/or the disinfection chamber can include one or more attributes configured to provide more efficient irradiation and/or higher disinfection rates.

### REFERENCE TO RELATED APPLICATIONS

The current application claims the benefit of co-pending U.S. Provisional Application No. 61/526,493, titled “Efficient Water Disinfection System Using Deep Ultraviolet Light Emitting Diodes,” which was filed on 23 Aug. 2011 and co-pending U.S. Provisional Application No. 61/624,398, titled “Efficient Water Disinfection System Using Deep Ultraviolet Light Emitting Diodes,” which was filed on 16 Apr. 2012, each of which is hereby incorporated by reference.

### GOVERNMENT LICENSE RIGHTS

This invention was made with government support under SBIR Phase II Grant No. IIP-1026217 awarded by the National Science Foundation. The government has certain rights in the invention.

### TECHNICAL FIELD

The disclosure relates generally to disinfection, and more particularly, to a solution for disinfecting a fluid, such as water, using deep ultraviolet light.

### BACKGROUND ART

Water treatment using ultraviolet (UV) radiation offers many advantages over other forms of water treatment, such as chemical treatment. For example, treatment with UV radiation does not introduce additional chemical or biological contaminants into the water. Furthermore, ultraviolet radiation provides one of the most efficient approaches to water decontamination since there are no microorganisms known to be resistant to ultraviolet radiation, unlike other decontamination methods, such as chlorination. UV radiation is known to be highly effective against bacteria, viruses, algae, molds and yeasts. For example, hepatitis virus has been shown to survive for considerable periods of time in the presence of chlorine, but is readily eliminated by UV radiation treatment. The removal efficiency of UV radiation for most microbiological contaminants, such as bacteria and viruses, generally exceeds 99%. To this extent, UV radiation is highly efficient at eliminating E-coli, Salmonella, Typhoid fever, Cholera, Tuberculosis, Influenza Virus, Polio Virus, and Hepatitis A Virus.

Intensity, radiation wavelength, and duration of radiation are important parameters in determining the disinfection rate of UV radiation treatment. These parameters can vary based on a particular target culture. The UV radiation does not allow microorganisms to develop an immune response, unlike the case with chemical treatment. The UV radiation affects biological agents by fusing and damaging the DNA of microorganisms, and preventing their replication. Also, if a sufficient amount of a protein is damaged in a cell of a microorganism, the cell enters apoptosis or programmed death. FIG. 1 shows an illustrative germicidal effectiveness curve of ultraviolet radiation according to the prior art. As illustrated, the most lethal radiation is at wavelengths of approximately 260 nanometers.

Ultraviolet radiation disinfection using mercury based lamps is a well-established technology. In general, a system for treating water using ultraviolet radiation is relatively easy to install and maintain in a plumbing or septic system. Use of UV radiation in such systems does not affect the overall system. However, it is often desirable to combine an ultraviolet purification system with another form of filtration since the UV radiation cannot neutralize chlorine, heavy metals, and other chemical contaminants that may be present in the water. Various membrane filters for sediment filtration, granular activated carbon filtering, reverse osmosis, and/or the like, can be used as a filtering device to reduce the presence of chemicals and other inorganic contaminants.

Mercury lamp-based ultraviolet radiation disinfection has several shortcomings when compared to deep ultraviolet (DUV) light emitting device (LED)-based technology, particularly with respect to certain disinfection applications. For example, in rural and/or off-grid locations, it is desirable for an ultraviolet purification system to have one or more of various attributes such as: a long operating lifetime, containing no hazardous components, not readily susceptible to damage, requiring minimal operational skills, not requiring special disposal procedures, capable of operating on local intermittent electrical power, and/or the like. Use of a DUV LED-based solution can provide a solution that improves one or more of these attributes as compared to a mercury vapor lamp-based approach. For example, in comparison to mercury vapor lamps, DUV LEDs: have substantially longer operating lifetimes (e.g., by a factor of ten); do not include hazardous components (e.g., mercury), which require special disposal and maintenance; are more durable in transit and handling (e.g., no filaments or glass); have a faster startup time; have a lower operational voltage; are less sensitive to power supply intermittency; are more compact and portable; can be used in moving devices; can be powered by photovoltaic (PV) technology, which can be installed in rural locations having no continuous access to electricity and having scarce resources of clean water; and/or the like.

### SUMMARY OF THE INVENTION

Aspects of the invention provide a solution for treating a fluid, such as water. The solution first removes a set of target contaminants that may be present in the fluid using a filtering solution. The filtered fluid enters a disinfection chamber where it is irradiated by ultraviolet radiation to harm microorganisms that may be present in the fluid. An ultraviolet radiation source and/or the disinfection chamber can include one or more attributes configured to provide more efficient irradiation and/or higher disinfection rates.

A first aspect of the invention provides a system comprising: a filtering unit comprising: an inlet for receiving unfiltered fluid; a filter material for removing a set of target contaminants from the unfiltered fluid; and an outlet for allowing filtered fluid to exit the filtering unit; a disinfection chamber fluidly connected with the outlet of the filtering unit; and an ultraviolet radiation source configured to emit ultraviolet radiation shone into the disinfection chamber onto the filtered fluid, wherein the disinfection chamber and the ultraviolet radiation source are configured to provide wave guiding of the ultraviolet radiation along a flow path of the filtered fluid.

A second aspect of the invention provides a system comprising: a filtering unit comprising: an inlet for receiving unfiltered fluid; a filter material for removing a set of target contaminants from the unfiltered fluid; and an outlet for allowing filtered fluid to exit the filtering unit; a disinfection chamber fluidly connected with the outlet of the filtering unit; an ultraviolet radiation source configured to emit ultraviolet radiation shone into the disinfection chamber onto the filtered fluid; and a plurality of objects floating in the filtered fluid in the disinfection chamber, wherein each of the plurality of objects has a refractive index lower than a refractive index of the filtered fluid.

A third aspect of the invention provides a method of treating a fluid comprising: passing the fluid through a filter material configured to remove a set of target contaminants from the fluid, wherein the filter material forms a disinfection chamber for filtered fluid; and operating an ultraviolet radiation source to emit ultraviolet radiation shone into the disinfection chamber onto the filtered fluid, wherein the disinfection chamber and the ultraviolet radiation source are configured to provide wave guiding of the ultraviolet radiation along a flow path of the filtered fluid.

The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative germicidal effectiveness curve of ultraviolet radiation according to the prior art.

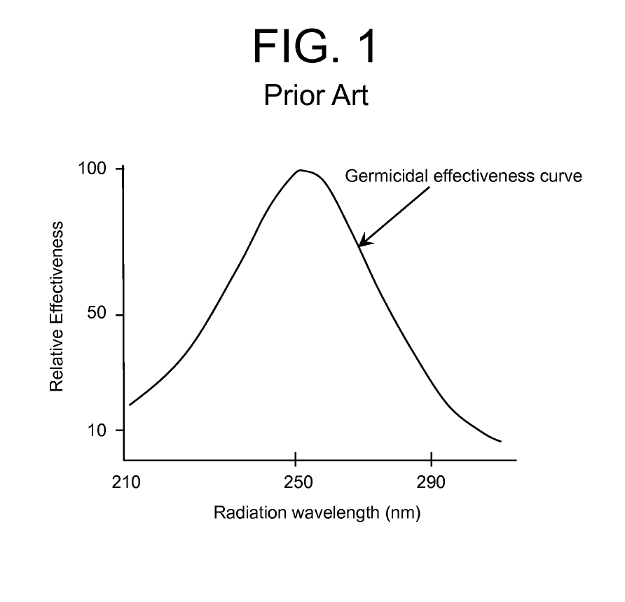

FIGS. 2A-2C show an illustrative assembly of a system for treating a fluid according to an embodiment.

FIG. 3 shows an illustrative disinfection chamber according to an embodiment.

FIG. 4 shows an illustrative disinfection chamber according to another embodiment.

FIG. 5 shows an illustrative disinfection chamber according to still another embodiment.

FIG. 6 shows an illustrative dispenser according to an embodiment.

FIG. 7 shows an illustrative system for treating a fluid according to an embodiment.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a solution for treating a fluid, such as water. The solution first removes a set of target contaminants that may be present in the fluid using a filtering solution. The filtered fluid enters a disinfection chamber where it is irradiated by ultraviolet radiation to harm microorganisms that may be present in the fluid. An ultraviolet radiation source and/or the disinfection chamber can include one or more attributes configured to provide more efficient irradiation and/or higher disinfection rates. As used herein, unless otherwise noted, the term “set” means one or more (i.e., at least one) and the phrase “any solution” means any now known or later developed solution.

Aspects of the invention are designed to improve the efficiency with which ultraviolet radiation is absorbed by a fluid, such as water. The improved design can provide a higher disinfection rate while requiring less power, making operation of the overall system more efficient. In a particular embodiment, the fluid is water and the system is configured to provide a reduction of microorganism (e.g., bacterial and/or viral) contamination in the water by at least a factor of two. In a more particular embodiment, the system provide approximately 99.9% decontamination of the water.

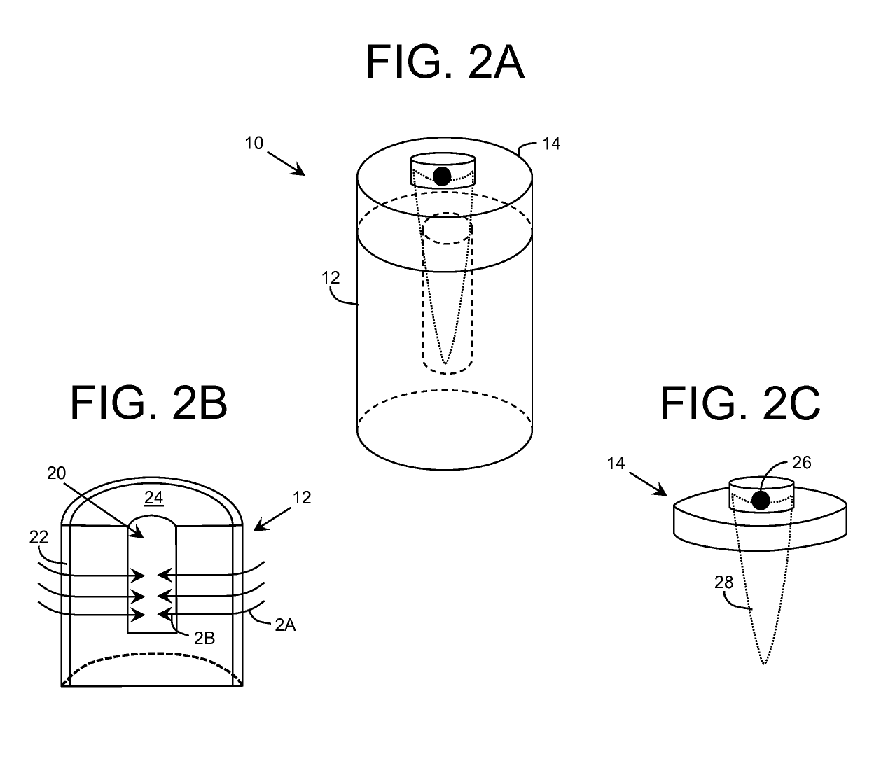

Turning to the drawings, FIGS. 2A-2C show an illustrative assembly 10 of a system for treating a fluid according to an embodiment. In particular, the assembly 10 includes a filtering unit 12 and a cap 14. As illustrated in FIG. 2B, the filtering unit 12 can be substantially cylindrical and include a hollow interior, which defines a disinfection chamber 20. During operation of the system, unfiltered fluid 2A can enter the filtering unit 12 through an inlet of the filtering unit 12 and filtered fluid 2B can exit the filtering unit 12 into the disinfection chamber 20 through an outlet of the filtering unit 12. In an embodiment, the inlet and outlet of the filtering unit 12 are permeable sides of the filtering unit 12, as illustrated. While not shown, the filtered fluid 2B can exit the disinfection chamber 20 and the assembly 10 after being irradiated as described herein.

The fluid 2A, 2B can comprise any type of fluid, including a liquid or a gas. In an embodiment, the fluid 2A, 2B is water, which can be treated to make the water potable. To this extent, as used herein, the terms “purification,” “decontamination,” “disinfection,” and their related terms mean treating the fluid 2A, 2B so that it includes a sufficiently low number of contaminants (e.g., chemical, sediment, and/or the like) and microorganisms (e.g., virus, bacteria, and/or the like) so that the fluid is safe for a desired interaction with a human or other animal. For example, the purification, decontamination, or disinfection of water means that the resulting water has a sufficiently low level of microorganisms and other contaminants that a typical human or other animal can consume the water without suffering adverse effects from microorganisms and/or contaminants present in the water. A target level of microorganisms and/or contaminants can be defined, for example, by a standards setting organization, such as a governmental organization.

The filtering unit 12 can comprise any combination of one or more of various types of filter materials and filtering solutions capable of removing one or more of various target contaminants that may be present in the fluid 2A as it passes there through. For example, the filtering unit 12 can comprise an outer sediment filter 22, which can comprise a filter material having a lattice structure, or the like, which is configured to remove target contaminants of a minimum size that may be present within the fluid 2A. Furthermore, the filtering unit 12 can comprise an inner filter material 24 capable of removing one or more target contaminants by adsorption. For example, the filter material 24 can comprise activated carbon, an ion exchange resin, or the like, and can be in the form of a ceramic, a block (e.g., carbon block), a granular fill, and/or the like. In this case, the filter material 24 can remove various chemical contaminants, such as heavy metals, chlorine, and/or the like, which may be present in the fluid 2A. Regardless, it is understood that the filtering unit 12 can incorporate any combination of one or more filtering solutions including, for example, reverse osmosis, membrane filtration (e.g., nanofiltration), ceramic filtration, sand filtration, ultrafiltration, microfiltration, ion-exchange resin, and/or the like.

In any event, when in the disinfection chamber 20, the filtered fluid 2B can be further treated by ultraviolet radiation. To this extent, as shown in FIGS. 2A and 2C, the cap 14 of the assembly 10 can include an ultraviolet radiation source 26, which is configured to emit ultraviolet radiation 28 shone into the disinfection chamber 20 (FIG. 2B), thereby irradiating the filtered fluid 2B (FIG. 2B) present therein. By removing at least some of the target contaminant(s) prior to shining the ultraviolet light 28 onto the filtered fluid 2B in the disinfection chamber 20, an amount of the ultraviolet light that is absorbed by contaminants that may be present in the unfiltered fluid 2A (FIG. 2B) is reduced. As a result, irradiation by the ultraviolet radiation 28 can more efficiently destroy biologically active microorganisms that are present in the filtered fluid 2B. In an embodiment, the beam of ultraviolet radiation 28 can be configured to provide improved uniformity of radiation throughout the disinfection chamber 20. For example, the ultraviolet radiation 28 shone into the disinfection chamber 20 can be a converging beam (as illustrated), a collimated beam, and/or the like. However, it is understood that the beam can comprise any type of beam.

In an embodiment, the ultraviolet radiation source 26 includes a set of ultraviolet light emitting diodes (LEDs), each of which is configured to emit radiation having a peak wavelength within the ultraviolet range of wavelengths, i.e., between 400 nanometers (nm) and 100 nm. In a more particular embodiment, the ultraviolet radiation emitted by an ultraviolet LED comprises deep ultraviolet radiation having a peak wavelength below 300 nanometers (nm). In a still more particular embodiment, the ultraviolet radiation emitted by an ultraviolet LED has a peak wavelength in a range between approximately 250 nm and approximately 290 nm. In another embodiment, the ultraviolet radiation source 26 includes a plurality of ultraviolet LEDs having a plurality of distinct peak wavelengths within the deep ultraviolet range of wavelengths, which can improve germicidal efficiency for targeting a plurality of types of microorganisms that may be present in the filtered fluid 2B.

The ultraviolet radiation 28 emitted by the ultraviolet radiation source 26 can be shone into the disinfection chamber 20 using any solution. For example, the ultraviolet radiation source 26 can comprise a set of ultraviolet LEDs located in the cap 14, which are located such that the ultraviolet radiation 28 emitted by each of the set of ultraviolet LEDs directly enters the disinfection chamber 20. Similarly, the ultraviolet radiation source 26, the cap 14, and/or the filtering unit 12 can include one or more waveguide structures, which direct ultraviolet radiation 28 emitted from a set of ultraviolet LEDs so that it is shone into the disinfection chamber 20 from a target location and/or has a set of desired attributes (e.g., is a converging beam).

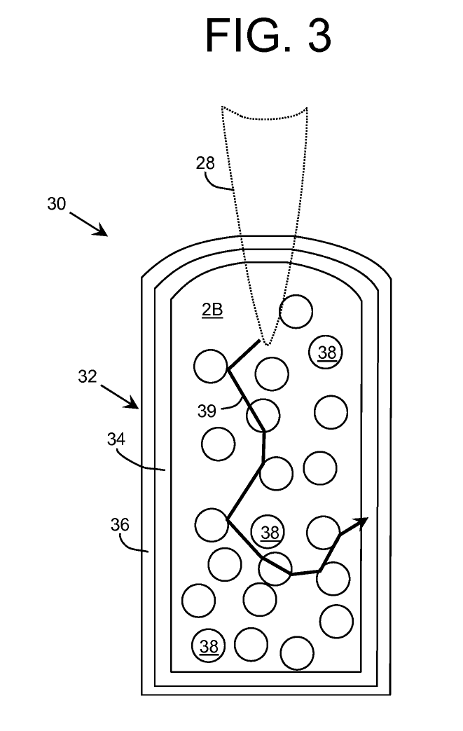

The disinfection chamber 20 can include one or more attributes to improve the efficiency of the ultraviolet irradiation 28. To this extent, FIG. 3 shows an illustrative disinfection chamber 30 according to an embodiment. As described herein, filtered fluid 2B can enter the disinfection chamber 30, where it is irradiated by ultraviolet (e.g., deep ultraviolet) radiation 28. In this case, the disinfection chamber 30 can include a chamber wall 32 composed of an ultraviolet reflective material (e.g., mirror), which will provide increased scattering of the ultraviolet radiation within the disinfection chamber 30 and a reduced loss of ultraviolet radiation 28 from the disinfection chamber 30. For example, the chamber wall 32 can comprise a low index of refraction layer of material 34 covering a layer of reflective material 36. In an embodiment, the layer of reflective material 36 is formed of an aluminum-based material, such as alumina, which has a relatively high reflectivity coefficient for ultraviolet radiation. The low index of refraction layer of material 34 can be formed of any type of material having a lower index of refraction than the fluid 2B, including: aerogel; a composite material comprising, for example, a layer of air and a thin layer of fused silica; and/or the like. Inclusion of the low refraction layer 34 will cause ultraviolet radiation 28 to be totally internally reflected (TIR) at an interface between the fluid 2B and the low refraction layer 34 for rays of ultraviolet radiation 28 propagating at angles to the interface normal that are greater than TIR angles.

Further improvement of scattering of the ultraviolet radiation 28 can be obtained by including a plurality of objects 38 floating in the filtered fluid 2B. Each of the objects 38 can have an index of refraction for the ultraviolet radiation 28 that is lower than the index of refraction for the ultraviolet radiation 28 of the filtered fluid 2B. As illustrated by the illustrative path 39 of an ultraviolet ray within the disinfection chamber 30, the ultraviolet radiation 28 will experience a total internal reflection (TIR) from water to object 38, which causes the ultraviolet radiation 28 to scatter, and leads to an increase in the length of the ultraviolet optical path 39 through the filtered fluid 2B. Increasing the length of the path 39 can result in a higher percentage of target microorganisms being harmed by the ultraviolet radiation 28, thereby improving the disinfection rate of the ultraviolet radiation 28.

An object 38 can comprise any type of material (including a fluid) having a refractive index that is lower than the refractive index of the filtered fluid 2B. In an embodiment, the refractive index is much lower (e.g., approximately 0.2 or more lower) than that of the filtered fluid 2B for the corresponding ultraviolet radiation 28. For example, when the filtered fluid 2B is water, which has an index of refraction of approximately 1.3, the object 38 can comprise an index of refraction of approximately 1.1 or less. In a further embodiment, an object 38 comprises a gaseous bubble, such as a bubble of atmospheric air, carbon dioxide, and/or the like. In this case, the treatment assembly 10 (FIG. 2A) can include a bubble generator, and the disinfection chamber 30 can include a set of inlets through which the gas/air from the bubble generator is introduced to create a desired amount of the bubbles 38 within the disinfection chamber 30 in the desired locations. Alternatively, the bubbles 38 can be present in the filtered fluid 2B when it enters the disinfection chamber 30. In another embodiment, an object 38 can comprise a material that will not dissolve within the filtered fluid 2B and can be contained within the disinfection chamber 30. For example, an object 38 can comprise a floater, which can be formed of a material that is sufficiently light to float within the filtered fluid 2B and can be contained within the disinfection chamber 30. In an embodiment, one or more floaters are made of hydrophobic alumina aerogel. While the objects 38 are shown as having a spherical shape, it is understood that this is only illustrative, and the objects 38 can include various objects 38 having any desired shape.

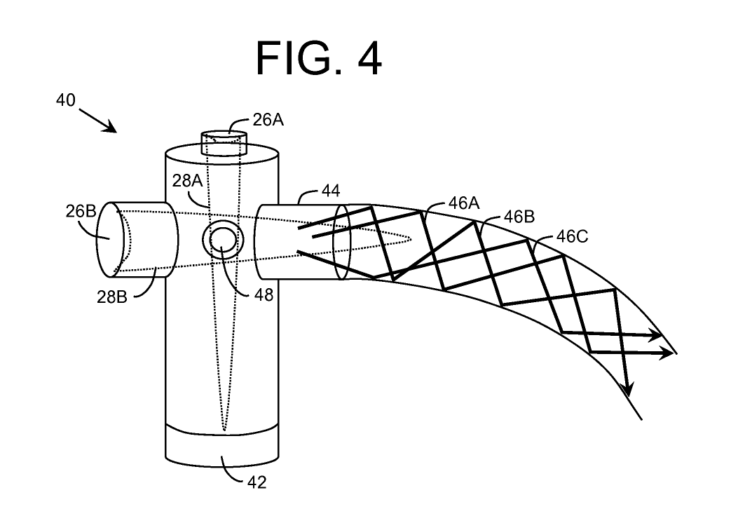

A disinfection chamber described herein can include various other components and/or attributes to improve an effectiveness and/or efficiency of the ultraviolet radiation treatment. For example, FIG. 4 shows an illustrative disinfection chamber 40 according to another embodiment. The disinfection chamber 40 includes two UV radiation sources 26A, 26B, each of which emits ultraviolet radiation 28A, 28B, respectively. The UV radiation sources 26A, 26B and ultraviolet radiation 28A, 28B can be configured as described herein.

During operation, a fluid can enter the disinfection chamber 40 through an inlet located in a lower end 42, flow in a generally upward direction through the disinfection chamber 40 towards the UV radiation source 26A, and exit the disinfection chamber 40 through an outlet 44 in a direction opposite the UV radiation source 26B. While the UV radiation 28A, 28B and corresponding fluid flows are shown as being at a substantially right angle to one another, it is understood that the UV radiation 28A, 28B and corresponding fluid flow can be at any angle. Furthermore, the disinfection chamber 40 can be located within the cylindrical filtering unit 12 (FIG. 2B), in which case filtered fluid 2B (FIG. 2B) can enter the disinfection chamber 40 through the side walls of the disinfection chamber 40 and the lower end 42 can be capped. In this case, the UV radiation source 26B and/or the outlet 44 can be embedded in the walls of the filtering unit 12.

In any event, the UV radiation 28B, and the corresponding location of the UV radiation source 26B, can be configured to provide maximum wave guiding for the UV radiation 28B in the fluid stream as it exits the disinfection chamber 40 through the outlet 44. For example, a channel in the flowing fluid can act as a waveguide for the UV radiation 28B as shown by the illustrative ultraviolet radiation rays 46A-46C. For a stream of water, the wave guiding can be achieved when the water stream has an interface with a material having a lower refractive index, such as atmospheric air. To this extent, the fluid flow can be an open air fluid flow as it exits the disinfection chamber 40 through the outlet 44.

Furthermore, the disinfection chamber 40 is shown including at least one sensor 48. The sensor 48 can be configured to acquire data corresponding to a level of contamination in the fluid, and provide the data for processing by a computer system. In response, the computer system can adjust operation of the UV radiation sources 26A, 26B based on a determined level of contamination in the fluid. In an embodiment, the computer system can employ photoluminescence to detect the presence and/or density of a microorganism present in the fluid. For example, the sensor 48 can comprise an UV fluorescence sensor, an UV absorbance sensor, and/or the like. In this case, the sensor 48 can be placed in the disinfection chamber 40 away from the UV radiation 28A, 28B beam paths (e.g., located on an interior wall of the disinfection chamber 40). The UV fluorescence sensor 48 can acquire data corresponding to a scattering of UV radiation within the disinfection chamber 40. The computer system can process the data corresponding to the scattering of UV radiation to correlate it with a level of contamination in the fluid, and make any adjustments to the operation of the UV radiation sources 26A, 26B accordingly. Similarly, the computer system can process data acquired by the sensor 48 to maintain a target level of ultraviolet flux within the disinfection chamber 40.

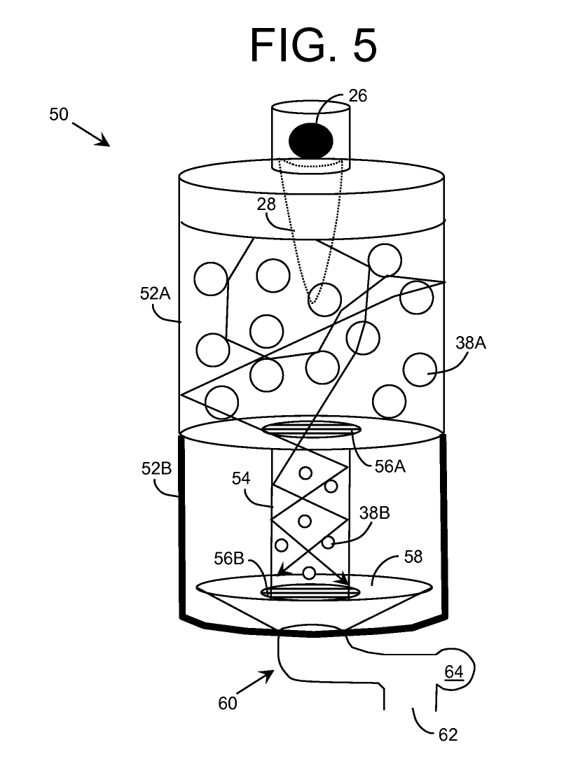

FIG. 5 shows an illustrative disinfection chamber 50 according to still another embodiment. The disinfection chamber 50 includes a first area 52A into which UV radiation 28 emitted by an UV radiation source 26 is shone. Furthermore, the first area 52A can include a plurality of objects 38A having a low index of refraction as described herein. The fluid, such as a filtered fluid, can enter the first area 52A via any type of inlet, such as an opening in a side of the first area 52A, permeable side walls of the first area 52A, and/or the like. Within the first area 52A, the fluid can be exposed to the ultraviolet radiation 28 as described herein.

The fluid can exit the first area 52A through one or more outflow channels 54, which are present within a second area 52B of the disinfection chamber 50. An outflow channel 54 also can include a plurality of objects 38B having a low index of refraction as described herein. Furthermore, an interior of the second area 52B can be reflective of the ultraviolet radiation 28. The outlets of the first area 52A and the outflow channel 54 each can comprise a filter 56A, 56B, respectively, which can prevent the corresponding objects 38A, 38B, respectively, from exiting the area. In an embodiment, each filter 56A, 56B is formed of an at least partially ultraviolet transparent material. An illustrative material for the filters 56A, 56B includes, for example, fused silica. Regardless, each filter 56A, 56B can comprise a mesh with relatively large openings that are sufficiently small to prevent the objects 38A, 38B from passing there through, and/or the like. By utilizing relatively large openings, the filter will allow a higher percentage of the ultraviolet radiation to pass there through.

During operation of the disinfection chamber 50, the wave guiding of the UV radiation 28 is achieved along each outflow channel 54, which can be positioned opposite the UV radiation source 26. Inclusion of the objects 38B in the outflow channel 54 provide for additional scattering of the UV radiation, and provide additional reflective surfaces to enable UV radiation reflected from the reflective walls of the second area 52B to enter UV wave guiding modes. The reflective walls of the second area 52B also can reduce the possibility of an unintended exposure to the UV radiation 28 by containing the UV radiation 28 within the disinfection chamber 50.

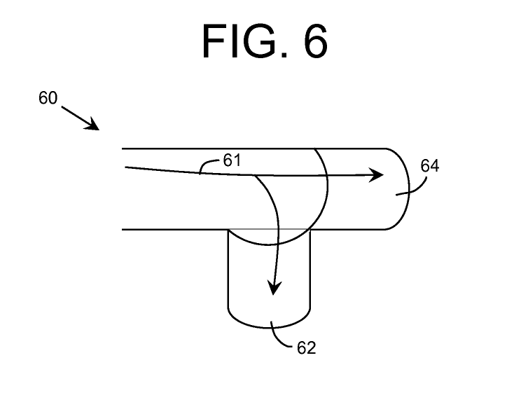

In any event, the fluid can be collected in a funnel 58 and dispensed out of the disinfection chamber 50 via a dispenser 60. FIG. 6 shows an illustrative dispenser 60 according to an embodiment. As illustrated in FIGS. 5 and 6, a stream of fluid 61 can exit the disinfection chamber, such as disinfection chamber 50, and flow through an outlet 62 of the treatment system. Near the outlet, the dispenser 60 can include a set of I/O devices 64, which are configured to provide data corresponding to a level of contamination in the fluid for processing by a computer system. For example, the set of I/O devices 64 can include a photoluminescence sensor (e.g., an UV fluorescence sensor, an UV absorbance sensor, and/or the like), which can acquire data corresponding to a presence and/or density of microorganisms in the stream of the fluid 61. The data can be processed by a computer system, which in turn can adjust operation of the ultraviolet radiation source 26 using a feedback loop in order to regulate the intensity of the ultraviolet radiation 28 within the disinfection chamber 50 to meet the target purity levels for the fluid 61 as described herein. Such a feedback loop can optimize the UV radiation intensity within the disinfection chamber 50 with respect to both meeting the target purity levels and efficient operation of the UV radiation source 26. Furthermore, the set of I/O devices can include one or more output devices, such as a radiation (e.g., visible, infrared, ultraviolet, and/or the like) source, which can be operated by the computer system to emit radiation used to acquire the data, such as the photoluminescence data.

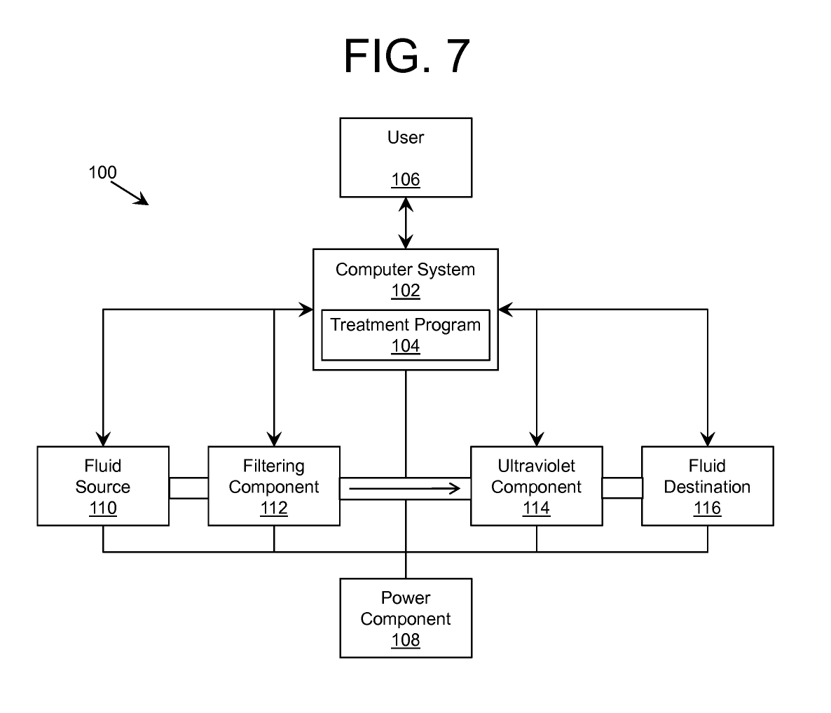

FIG. 7 shows an illustrative system 100 for treating a fluid according to an embodiment. In particular, the system 100 includes a computer system 102, which can perform a process described herein in order to treat the fluid as it travels from a fluid source 110 to a fluid destination 116. In particular, the computer system 102 is shown including a treatment program 104, which makes the computer system 102 operable to treat the fluid by performing a process described herein.

In an embodiment, the computer system 102 comprises a general purpose computing device, which includes a processor, a storage hierarchy, and one or more input/output (I/O) devices. In this case, the computer system 102 can execute the treatment program 104, which can be stored in the storage hierarchy in order to implement a process for treating the fluid as described herein. However, it is understood that the computer system 102 can comprise any type of computing device, which may or may not utilize program code, in order to implement a process for treating the fluid as described herein. Furthermore, it is understood that the computer system 102 can include more than one computing device, each of which can perform a portion of a process for treating the fluid as described herein.

The computer system 102 can include one or more I/O devices for interacting with one or more components of the fluid source 110 and/or the fluid destination 116. For example, the computer system 102 can operate a pump, a valve, and/or the like, which controls the flow of the fluid from the fluid source 110 to the filtering component 112 and/or from the ultraviolet component 114 to the fluid destination 116. The computer system 102 can manage the flow control to slow/speed the flow of the fluid, to stop/start the flow of the fluid, route the flow of the fluid, and/or the like. Computer system 102 can perform the flow control in response to a determined level of contamination in the fluid, a determination of one or more malfunctioning components, a target amount of fluid to be treated (e.g., as provided by a user 106), and/or the like.

As discussed herein, the fluid can pass through the filtering component 112, where target contaminants are removed from the fluid, prior to entering the ultraviolet component 114, where the fluid is irradiated by ultraviolet radiation to harm microorganisms that may be present in the fluid. The computer system 102 can obtain data corresponding to a contamination level of the fluid from a set of sensors located adjacent to or within the ultraviolet component 114. For example, the computer system 102 can receive data from a sensor located prior to the fluid entering the ultraviolet component 114. Similarly, the computer system 102 can receive data from one or more sensors located within the ultraviolet component 114 (e.g., within the disinfection chamber) and/or one or more sensors located as the fluid is exiting the ultraviolet component 114 (e.g., within the dispenser) as shown and described herein. In any event, the computer system 102 can utilize the data acquired by the sensor(s) to determine a level of contamination of the fluid at the given location, confirm that various components, such as the ultraviolet radiation source(s), a bubble generator, and/or the like, are properly functioning, adjust operation of one or more of the components, and/or the like. The computer system 102 can use the information, such as the level of contamination, to determine a target amount of ultraviolet radiation to use in treating the fluid to reduce the level of contamination, if necessary, to a level at or below a target level of contamination (e.g., as provided by a user 106).

The computer system 102 can operate the set of UV radiation sources in the ultraviolet component 114 in a manner configured to further improve germicidal efficiency of the ultraviolet irradiation. For example, the computer system 102 can pulse the set of UV radiation sources rather than continuously operating the UV radiation sources. The computer system 102 can implement a pulsing solution configured to provide for a quasi-continuous UV flux at a target level within the contamination chamber while keeping the total power consumption of the system 100 below a target level. Furthermore, when the set of UV radiation sources includes UV radiation sources having a plurality of distinct peak wavelengths, the computer system 102 can implement a pulsing solution configured to maintain the quasi-continuous UV flux for each of the plurality of distinct peak wavelengths. While a single filtering component 112 and single ultraviolet component 114 are shown between the fluid source 110 and the fluid destination 116, it is understood that any number of filtering components 112 and ultraviolet components 114 can be located along the fluid flow path between the fluid source 110 and the fluid destination 116.

The system 100 is further shown including a power component 108, which can be configured to provide power, if necessary, to any devices in the various other components of the system 100. For example, the power component 108 can provide power to a pump, a filtering component, the UV radiation source(s), the computer system 102, a bubble generator, and/or the like. The power component 108 can provide an interface to power available via an electric grid and/or generate some or all of the power required for the system 100. In an embodiment, the power component 108 provides all of the power for the system 100 without connection to an electric grid. The power component 108 can include any combination of one or more types of power generators including, for example, a solar cell, a bacteria-powered battery, a microbial fuel cell, a wind generator, and/or the like. Furthermore, some of the power can be mechanical power (e.g., for pumping the fluid), which can be generated using any mechanical power solution including, for example, a hand crank, a wind driven mechanical system, and/or the like.

It is understood that aspects of the invention described herein can be implemented in various types of applications. For example, aspects of the invention can be implemented in any type of application requiring disinfection of a fluid, such as water. These applications can include, for example: a community water supply system; a disaster relief water supply system; a water supply system for highly mobile groups of individuals, such as troops; a hand powered filter pump for remote locations, such as camping and other outdoor activities; water disinfection for a drinking water bottle; a backpack hydration system; and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system comprising:
a filtering unit comprising:
an inlet for receiving unfiltered fluid;
a filter material for removing a set of target contaminants from the unfiltered fluid; and
an outlet for allowing filtered fluid to exit the filtering unit;
a disinfection chamber fluidly connected with the outlet of the filtering unit; and
an ultraviolet radiation source configured to emit ultraviolet radiation shone into the disinfection chamber onto the filtered fluid, wherein the disinfection chamber and the ultraviolet radiation source are configured to provide wave guiding of the ultraviolet radiation along a flow path of the filtered fluid.

2. The system of claim 1, further comprising a plurality of objects floating in the filtered fluid in the disinfection chamber, wherein each of the plurality of objects has a refractive index lower than a refractive index of the filtered fluid.

3. The system of claim 2, wherein the plurality of objects includes a plurality of gaseous bubbles.

4. The system of claim 2, wherein the plurality of objects includes a plurality of floaters, and wherein each floater comprises hydrophobic alumina aerogel.

5. The system 1, further comprising:
a computer system configured to control the ultraviolet radiation source; and
a set of sensors configured to acquire data corresponding to a level of contamination in the filtered fluid, wherein the computer system controls the ultraviolet radiation source using the data acquired by the set of sensors.

6. The system of claim 1, wherein the ultraviolet radiation source includes a plurality of deep ultraviolet light emitting diodes configured to emit deep ultraviolet light having a plurality of different peak wavelengths.

7. The system of claim 1, wherein at least one ultraviolet radiation source is configured to emit ultraviolet radiation directed to at least one channel of the filtered fluid exiting the disinfection chamber.

8. The system of claim 7, wherein an outlet of the disinfection chamber includes a plurality of objects floating in the filtered fluid, wherein each of the plurality of objects has a refractive index lower than a refractive index of the filtered fluid.

9. The system of claim 1, wherein the disinfection chamber includes an inner surface highly reflective of the ultraviolet radiation.

10. The system of claim 1, further comprising a power source configured to power the ultraviolet source without connection to a power grid.

11. The system of claim 10, wherein the power source includes at least one power source selected from the group consisting of: a solar cell, a bacteria-powered battery, a microbial fuel cell, a mechanical pump, and a wind turbine.

12. A system comprising:
a filtering unit comprising:
an inlet for receiving unfiltered fluid;
a filter material for removing a set of target contaminants from the unfiltered fluid; and
an outlet for allowing filtered fluid to exit the filtering unit;
a disinfection chamber fluidly connected with the outlet of the filtering unit;
an ultraviolet radiation source configured to emit ultraviolet radiation shone into the disinfection chamber onto the filtered fluid; and
a plurality of objects floating in the filtered fluid in the disinfection chamber, wherein each of the plurality of objects has a refractive index lower than a refractive index of the filtered fluid.

13. The system of claim 12, wherein the plurality of objects includes at least one of: a plurality of floaters or a plurality of bubbles.

14. The system of claim 13, wherein the plurality of objects includes a plurality of bubbles, the system further comprising a bubble generator configured to generate the plurality of bubbles in the disinfection chamber.

15. The system of claim 12, further comprising:
a computer system configured to control the ultraviolet radiation source; and
a set of sensors configured to acquire data corresponding to a level of contamination in the filtered fluid, wherein the computer system controls the ultraviolet radiation source using the data acquired by the set of sensors.

16. The system of claim 15, wherein the ultraviolet radiation source includes a plurality of ultraviolet light emitting diodes having a plurality of distinct peak wavelengths, and wherein the computer system pulses the plurality of ultraviolet light emitting diodes to provide a quasi-continuous ultraviolet flux for each of the plurality of distinct peak wavelengths.

17. A method of treating a fluid comprising:
passing the fluid through a filter material configured to remove a set of target contaminants from the fluid, wherein the filter material forms a disinfection chamber for filtered fluid; and
operating an ultraviolet radiation source to emit ultraviolet radiation shone into the disinfection chamber onto the filtered fluid, wherein the disinfection chamber and the ultraviolet radiation source are configured to provide wave guiding of the ultraviolet radiation along a flow path of the filtered fluid.

18. The method of claim 17, further comprising providing a plurality of objects floating in the filtered fluid in the disinfection chamber, wherein each of the plurality of objects has a refractive index lower than a refractive index of the filtered fluid.

19. The method of claim 17, further comprising:
obtaining data corresponding to a level of contamination in the filtered fluid; and
adjusting operation of the ultraviolet radiation source using the data corresponding to the level of contamination.

20. The method of claim 17, wherein the ultraviolet radiation source includes a plurality of ultraviolet light emitting diodes having a plurality of distinct peak wavelengths, and wherein the operating includes pulsing the plurality of ultraviolet light emitting diodes to provide a quasi-continuous ultraviolet flux for each of the plurality of distinct peak wavelengths.
